(19) United States
(12) Patent Application Publication
(10) Pub. No.: US 2002/0072443 A1
(43) Pub. Date: Jun. 13, 2002

(54) Sealed chain

(76) Inventors: Makoto Kanehira, Osaka (JP); Tomoyuki Saji, Osaka (JP)

Correspondence Address: HOWSON AND HOWSON, ONE SPRING HOUSE CORPORATION CENTER, BOX 457, 321 NORRISTOWN ROAD, SPRING HOUSE, PA, 19477, US

(21) Appl. No.: 09/989,740

(22) Filed: Nov. 20, 2001

(30) Foreign Application Priority Data
Nov. 20, 2000 (JP) 353285/2000

(51) Int. Cl. F16G 13/02

(52) U.S. Cl. 474/207

(57) ABSTRACT

A sealed chain includes an elastic seal member fitted around the circumferential surface of a pin and disposed between the inner side surface of an outer link plate and the end face of a bushing. The end face of the bushing is retracted from the outer side surface of an inner link plate so that an annular recess or space is formed between the end face of the bushing, the outer circumferential surface of the pin and the peripheral wall of a bushing hole in the inner link plate. The seal member is partly received in the annular space. The width of the sealed chain is equal to that of a standard chain even when a relatively thick seal member such as an O-ring is used.

### BACKGROUND OF THE INVENTION

1. Field of the Invention

The present invention relates generally to a chain used for power transmission or conveyance, and more particularly to a sealed chain capable of holding a lubricating agent between a pin and a bushing against leakage and also preventing foreign matter from entering between the pin and the bushing.

2. Description of the Related Art

Sealed chains are known as disclosed in Japanese Utility Model Laid-open Publication No. 54-45864.The disclosed sealed chain, as illustrated here in FIG. 8, includes a pin 3 with opposite ends press-fit in outer link plates 4, 4, a bushing 1 substantially concentrically fitted around an outer circumferential surface of the pin 3 and having opposite end portions press-fit in inner link plates 2, 2, a roller 5 rotatably fitted around an outer circumferential surface of the bushing 1, and an annular seal ring 6 of an elastic material fitted around the outer circumferential surface of that portion la of the bushing 1 projecting outward from an outer side surface of each inner link plate 2 and disposed in an elastically compressed state in a space formed between opposite side surfaces of the inner and outer link plates 2 and 4. The seal ring 6 has an annular body portion 6a of a circular cross section having an inside diameter substantially equal to the outside diameter of the bushing 1, and an annular flange portion 6b of a generally Y-shaped cross section extending from the body portion 6a in a radial outward direction.

Another known sealed chain is disclosed in Japanese laid-open Utility Model No. 55-26194. The disclosed sealed chain, as illustrated here in FIG. 9, includes a pin 3 with opposite ends press-fit in outer link plates 4, 4, a bushing 1 substantially concentrically fitted around an outer circumferential surface of the pin 3 and having opposite end portions press-fit in inner link plates 2, 2, a roller 5 rotatably fitted around an outer circumferential surface of the bushing 1, and an annular seal ring 7 of an elastic material fitted around the outer circumferential surface of the pin 3 and disposed in an elastically compressed state in a space formed between opposite side surfaces of the inner and outer link plates 2 and 4. The seal ring 7 has an enlarged annular body portion 7a of a circular cross section, and an outer seal lip 7b extending from the body portion 7a in a radial outward direction and elastically engaging the opposite side surfaces of the inner and outer link plates 2 and 4.

Still another known sealed chain is disclosed in Japanese Utility Model Registration No. 3008114. Though not shown here, the disclosed sealed chain includes a pin with opposite ends press-fit in outer link plates, a bushing substantially concentrically fitted around an outer circumferential surface of the pin and having opposite ends press-fit in inner link plates, and a roller rotatably fitted around an outer circumferential surface of the bushing. Each of the outer link plates and an adjacent one of the inner link plates are disposed closely to such an extend that a relatively small space is defined between the inner and outer link plates. The busing has opposite end faces so designed as to either project from, or lie flush with, outer side surfaces of the inner link plates. In the former case, the spacing between the inner and outer link plates is further reduced. A thin seal member comprising a flat seal ring is disposed in the small space between the inner and outer link plates and also between an end face of the bushing and the inner side surface of the outer link plate, so as to embrace the pin.

The conventional sealed chain shown in FIG. 8 has a drawback that since the annular seal ring 6 disposed between the opposite surfaces of the inner and outer link plates 2 and 4 is fitted around the bushing portion 1a projecting outward from the outer side surface of the inner link plate 2, the outer link plate 4 must be displaced in an axial outward direction of the pin so as keep the necessary space for installation of the annular seal ring 6. This makes the sealed chain become larger in width than standard chains defined by JIS (Japan Industrial Standards), ANSI (American National Standards Institute), ISO (International Organization for Standardization), BS (British Standard) and so on. As a consequence, the sealed chain is not exchangeable with the standard chains, is heavier than the standard chains and has a smaller rupture strength than the standard chains. Additionally, since the seal ring 6 is disposed on the projecting bushing portion 1a, when the sealed chain is caused to bend or flex, the point of application of a moment is located relatively far from the axis of pivotal movement of the link plates formed by the axis of the pin 2. With this arrangement, the moment acting on the seal ring 6 increases with the result that the sealed chain is subjected to a large bending resistance produced by the seal ring and the service life of the seal ring is shortened.

In the conventional sealed chain shown in FIG. 9, due to the seal ring 7 fitted around the pin 3 in a space formed between opposite side surfaces of the inner and outer link plates 2 and 4, the outer link plate 4 must be displaced in a radial outward direction of the pin 3 so as to provide an enough space for installation of the seal ring 7. This makes the sealed chain wider than the standard chains. A sealed chain larger in width than the standard chains is not exchangeable with a standard chain, is heavier than a standard chain, and has a smaller rupture strength than a standard chain.

The conventional sealed chain disclosed in Japanese Utility Model Registration No. 3008114 requires a thin seal member comprising a flat seal ring and cannot be used with a relatively thick seal member such as O-ring used extensively. Due to the difficulty in using an inexpensive O-ring, the conventional sealed chain is relatively expensive to manufacture. Additionally, the sealing power and durability of the flat seal ring (thin seal member) are not compatible to that of the O-ring (thick seal member).

### SUMMARY OF THE INVENTION

It is, accordingly, an object of the present invention to provide a sealed chain which is free from problems such as increased width, reduced rupture strength, increased weight, loss of the exchangeability with standard chains, increased bending resistance and shortened seal life, even when a relatively thick seal member, such as an O-ring, is used.

To achieve the foregoing object, according to the present invention, there is provided a sealed chain comprising: two opposed inner link plates each having a bushing hole formed therein; a bushing having opposite end portions press-fit in the bushing holes of the inner link plates; two opposed outer link plates disposed exteriorly of the inner link plates in the widthwise direction of the chain; a pin loosely fitted in the bushing and having opposite end portions firmly connected to the outer link plates, there being a first space defined between an inner side surface of each of the outer link plates and an outer side surface of one inner link plate opposite to the outer link plate; and a seal member of an elastic material fitted around an outer circumferential surface of the pin and disposed at least between the inner side surface of the outer link plate and an end face of the bushing. Each of the opposite end portions of the bushing and at least one of the outer circumferential surface of the pin and a peripheral wall of the bushing hole together define therebetween a second space connected to a first space, and the seal member is partly received in the second space.

In one preferred form of the present invention, the end face of the bushing is retracted from the outer side surface of the inner link plate, and the second space is defined between the end face of the bushing, the outer circumferential surface of the pin, and the peripheral wall of the bushing hole of the inner link plate. At least one of inner and outer peripheral edges of the end face is rounded, the rounded peripheral edge of the end face and one of the peripheral wall of the bushing hole of the inner link plate and the outer circumferential surface of the pin jointly form an axial end extension of the second space, and the seal member has an annular seal lip elastically engaged in the axial end extension of the second space.

The seal member may comprise an O-ring. As an alternative, the seal member may comprise a flanged O-ring having a body of a circular cross section and an annular flange extending from the circular body in a radial outward direction, in which instance the circular body is disposed between the inner side surface of the outer link plate and the end face of the bushing, and the annular flange is disposed between the inner side surface of the outer link plate and the outer side surface of the inner link plate. It is preferable that the circular body of the flanged O-ring has an amount of elastic deformation smaller than that of the annular flange of the flanged O-ring.

The sealed chain may further include an X-ring of an elastic material disposed between the inner side surface of the outer link plate and the outer side surface of the inner link plate. It is preferable that the O-ring has an amount of elastic deformation smaller than that of the X-ring.

In another preferred form of the present invention, the end face of the bushing lies flush with the outer side surface of the inner link plate, at least one of inner and outer peripheral edges of the end face is rounded, the second space is defined between the rounded peripheral edge of the end face and one of the peripheral wall of the bushing hole of the inner link plate and the outer circumferential surface of the pin, and the seal member has an annular seal lip elastically engaged in the second space. The radius of curvature of the rounded peripheral edge is greater than or equal to 1/10 of the thickness of the bushing and preferably is ¼ of the thickness of the bushing.

It is preferable that the end face of the bushing and the seal member define therebetween a closed annular space and retain a lubricating agent within the closed annular space.

In still another preferred form of the present invention, the end face of the bushing lies flush with the outer side surface of the inner link plate, at least one of inner and outer peripheral edges of the end face is beveled, the second space is defined between the beveled peripheral edge of the end face of the bushing and one of the peripheral wall of the bushing hole of the inner link plate and the outer circumferential surface of the pin, and the seal member has an annular seal lip elastically engaged in the second space. The width of the beveled peripheral edge is smaller than or equal to ½ of the thickness of the bushing and preferably is ¼ of the thickness of the bushing.

### BRIEF DESCRIPTION OF THE DRAWINGS

Preferred embodiments of the present invention will now be described in detail, by way of example only, with reference to the accompanying drawings, in which:

FIG. 1A is a fragmentary cross-sectional view of a main portion of a sealed chain, with a seal member omitted for clarity, according to a first embodiment of the present invention;

FIG. 1B is a view similar to FIG. 1A, but showing the sealed chain with a seal member installed therein;

FIG. 2 is a fragmentary cross-sectional view of a main portion of a sealed chain according to a second embodiment of the present invention;

FIG. 3 is a fragmentary cross-sectional view of a main portion of a sealed chain according to a third embodiment of the present invention;

FIGS. 4A and 4B are views similar to FIGS. 1A and 1B, respectively, but showing a main portion of a sealed chain according to a fourth embodiment of the present invention;

FIGS. 5A and 5B are views similar to FIGS. 1A and 1B, respectively, but showing a main portion of a sealed chain according to a fifth embodiment of the present invention;

FIGS. 6A and 6B are views similar to FIGS. 1A and 1B, respectively, but showing a main portion of a sealed chain according to a sixth embodiment of the present invention;

FIGS. 7A and 7B are views similar to FIGS. 1A and 1B, respectively, but showing a main portion of a sealed chain according to a seventh embodiment of the present invention;

FIG. 8 is a fragmentary cross-sectional view showing a main portion of a conventional sealed chain; and

FIG. 9 is a view similar to FIG. 8, but showing another conventional sealed chain.

### DETAILED DESCRIPTION OF THE PREFERRED EMBODIMENTS

The following description is merely exemplary in nature and is in no way intended to limit the invention or its application or uses.

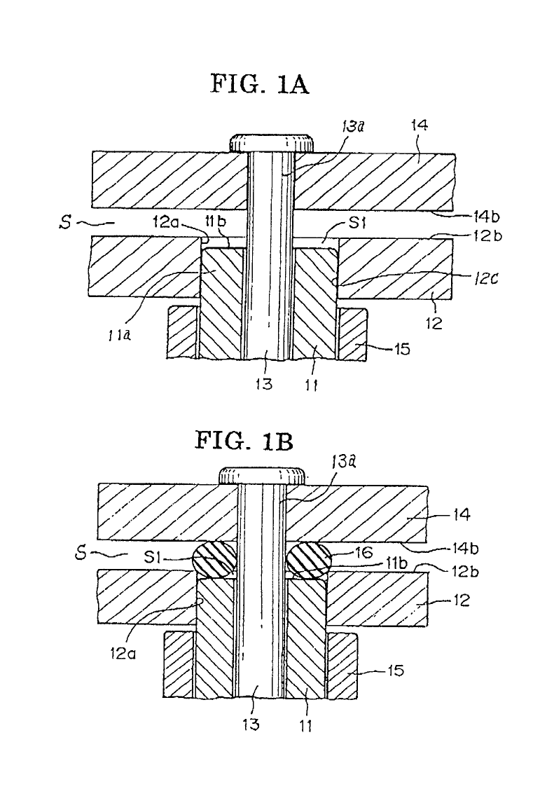

FIGS. 1A and 1B show a sealed chain according to a first embodiment of the present invention. As shown in FIG. 1A, the sealed chain comprises a bushing 11 having opposite end portions (one being shown) 11a press-fit in bushing holes 12c of two opposed inner link plates (one being shown) 12, and a pin 13 loosely fitted in the bushing 11 and having opposite end portions 13a firmly connected by crimping to two opposed outer link plates (one being shown) 14 disposed exteriorly of the inner link plates in the widthwise direction of the chain, there being a space S defined between opposite side surfaces 12b and 14b of the inner and outer link plates 12 and 14. A roller 15 is rotatably mounted on the bushing 11.

Each of the end portions 11a of the bushing 11 has an end face 11b retracted or offset backward from the outer side surface 12b of the inner link plate 12 so as to define, jointly with an outer circumferential surface of the pin 13 and a peripheral wall 12a of the bushing hole 12c of the inner link plate 11, an annular space or recess S1 connected to the space S defined between the inner and outer link plates 12 and 14.

As shown in FIG. 1B, a relatively thick seal member comprising an O-ring 16 (made of nitrile rubber) is fitted around the outer circumferential surface of the pin 13 and disposed in the space S between the opposite side surfaces 12b, 14b of the inner and outer link plates 12 and 14. The O-ring (seal member) 16 has a portion received in the annular space S1 formed between the end face 11b of the bushing 11, the outer circumferential surface of the pin 13 and the peripheral wall 12a of the bushing hole 12c of the inner link plate 12.

In the sealed chain shown in FIGS. 1A and 1B, the end face 11b of the bushing 11 does not protrude from the outer side surface 12b of the inner link plate 12 but is retracted from the outer side surface 12b so as to form a space S1 for accommodating therein part of the O-ring 16. With the space S1 thus provided, it is no longer necessary to displace the outer link plate 14 in an axial outward direction of the pin 13 so as to provide a necessary space for installation of the O-ring 16. This prevents the sealed chain from becoming larger in width than a standard chain even though a relatively thick seal member such as an O-ring 16 is used.

By virtue of the space S1 defined between an end portion 11a of the bushing 11, the peripheral wall 12a of the bushing hole 12c and the circumferential surface of the pin 13 for receiving therein a part of the seal member (O-ring) 16, the sealed chain has various advantages, as enumerated below.

(1) By virtue of the equal width, the sealed chain and the standard chain are interchangeable with each other.

(2) The sealed chain has a rupture strength compatible to that of the standard chain.

(3) The sealed chain is light in weight as compared to the conventional sealed chains.

(4) The O-ring 16 partly received in the space S1 is only minimally displaceable, if at all, in a radial direction and this provides an improving sealing effect.

(5) When used in a multiplex chain together with strands of standard chains, the sealed chain having the same width as the standard chains can operate reliably without interference with an adjacent standard chain.

(6) The O-ring used as a seal member in the sealed chain is inexpensive and hence is able to reduce the overall cost of the sealed chain.

(7) The O-ring 16 mounted on the pin 13 is subjected to a relatively small moment when the chain is caused to bend or flex, and this reduces the bending resistance exerted on the sealed chain and extends the service life of the O-ring 16.

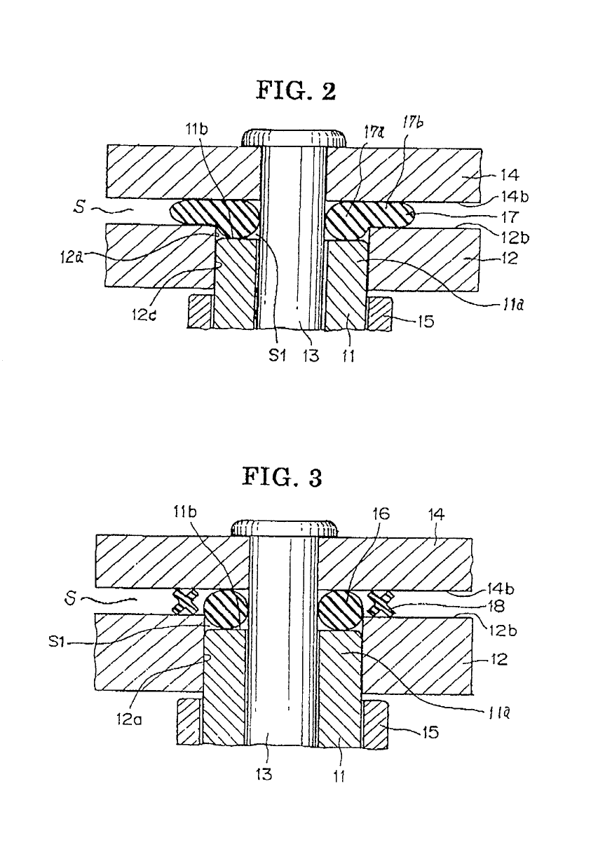

FIG. 2 shows a main portion of a sealed chain according to a second embodiment of the present invention. The sealed chain differs from the sealed chain of the first embodiment shown in FIGS. 1A and 1B only in that an elastic seal ring comprising a flanged O-ring 17 is used in place of the simple O-ring 16. Other structural parts of the sealed chain are the same as those shown in FIGS. 1A and 1B and further description thereof can, therefore, be omitted.

As shown in FIG. 2, the flanged O-ring 17 of the sealed chain is fitted around the outer circumferential surface of the pin 13 and disposed in a space S between opposite side surfaces 12b and 14b of the inner and outer link plates 12 and 14. A portion of the flanged O-ring 17 is received in an annular space S1 defined between the end face 11b of the bushing 11, the outer circumferential surface of the pin 13, and the peripheral wall 12a of a bushing hole 12c of the inner link plate 12. The flanged O-ring 17 has a body 17a of a circular cross section and an annular flange 17b extending from an upper part of the circular body 17a in a radial outward direction. The circular body 17a of the flanged O-ring 17 is disposed between the inner side surface 14b of the outer link plate 14 and the end face 11b of the bushing 11, and the flange 17b is disposed between the inner side surface 14b of the outer link plate 14 and the outer side surface 12b of the inner link plate 12.

In the sealed chain shown in FIG. 2, since the end face 11b of the bushing 11 does not protrude from the outer side surface 12b of the inner link plate 12 but is offset from the outer surface 12b so as to form a space SI for receiving therein part of the circular body 17a of the flanged O-ring 17, it is readily possible to provide a necessary space for installation of the flanged O-ring 17 without displacing the outer link plate 14 in an axial outward direction of the pin 13. Thus, the sealed chain can maintain a width equal to that of the standard chain.

The sealed chain shown in FIG. 2 has the same advantages described above with respect to the sealed chain shown in FIGS. 1A and 1B. A further advantageous effect can be achieved by the sealed chain of FIG. 2, as will become apparent from the following explanation.

The flanged O-ring 17 is so arranged as to satisfy the expression r1/r2>1 where r1 is the amount of elastic deformation of the annular flange 17b of the flanged O-ring 17 disposed between the outer side surface 12b of the inner link plate 12 and the inner side surface 14b of the outer link plate 14, and r2 is the amount of elastic deformation of the circular body 17a of the flanged O-ring 17 disposed between the end face 11b of the bushing 11 and the inner side surface 14b of the outer link plate 14. By thus arranging the flanged O-ring 17, when the sealed chain is subjected to a thrust load or force applied in the widthwise direction of the chain, the thrust load is born mainly by the annular flange 17b of the sealed O-ring 17. The circular body 17a is kept substantially free from the influence of the thrust load. The annular flange 17b having a larger amount of elastic deformation than the circular body 17a is susceptible to wear and deterioration in advance to the circular body 17a. However, the circular body 17a disposed interiorly of the annular flange 17b can hold a lubricating agent (not shown) between the pin 13 and the bushing 11 against leakage and prevent a foreign matter from entering between the pin 13 and the bushing 11 even after wear or deterioration of the annular flange 17b. The flanged O-ring 17 as a whole is able to achieve a prescribed sealing effect over a long period of use.

FIG. 3 shows a main portion of a sealed chain according to a third embodiment of the present invention. The sealed chain is different from the sealed chain of FIGS. 1A and 1B only in that an X-ring 18 of an elastic material is disposed concentrically on an exterior side of the O-ring 16.

As shown in FIG. 3, the O-ring 16, made of nitrile rubber, is fitted around the outer circumferential surface of a pin 13 and disposed between the inner side surface 14b of an outer link plate 14 and an end face 11b of a bushing 11, with a portion of the O-ring 16 being received in an annular recess or space S1 formed between the end face 11b of the bushing 11, the outer circumferential surface of the pin 13, and the peripheral wall 12a of a bushing hole 12c of the inner link plate 12. The X-ring 18 is disposed between the outer side surface 12b of the inner link plate 12 and the inner side surface 14b of the outer link plate 14.

In the sealed chain shown in FIG. 3, since the end face 11b of the bushing 11 does not protrude from the outer side surface 12b of the inner link plate 12 but is retracted from the outer side surface 12b so as to form a space S1 for receiving therein a portion of the O-ring 16, a necessary space for installation of the O-ring 16 and the X-ring 18 can be provided without displacing the outer link plate 14 in an axial outward direction of the pin 13. This prevents the sealed chain from becoming wider than the standard chain.

The O-ring 16 and the X-ring 18 are so arranged as to satisfy the expression r1/r2>1 where r1 is the amount of elastic deformation of the X-ring 18 and r2 is the amount of elastic deformation of the O-ring 16. By thus arranging the O- and X-rings 16 and 18, the sealed chain can achieve the same effect as the sealed chain shown in FIG. 2.

In the sealed chain shown in FIG. 3, it is preferable that the O-ring 16 is made of an elastic material, such as nitrile rubber, having a higher wear resistance than the elastic material used for forming the X-ring 18. The material for the X-ring 18 is preferably determined by environmental conditions in which the sealed chain is used. Stated more specifically, when the sealed chain is used in a moist environment, the X-ring 18 is preferably made of an elastic material having a high water resistance. When the sealed chain is used in the presence of an organic solvent or a chemical, the X-ring 18 is preferably made of an elastic material, such as butyl rubber, having a high corrosion resistance and a high environmental resistance. When the sealed chain is used at high temperatures, the X-ring 18 is preferably made of an elastic material having a high temperature resistance such as fluororubber, or a high thermal conductive material such as silicone rubber. When the sealed chain is used at low temperatures, the X-ring 18 is preferably made of an elastic material, such as urethane rubber, having a high low-temperature resistance. When the sealed chain is subjected to light rays while in use, the X-ring 18 is preferably made of an elastic material, such as acrylic rubber, having a high light resistance.

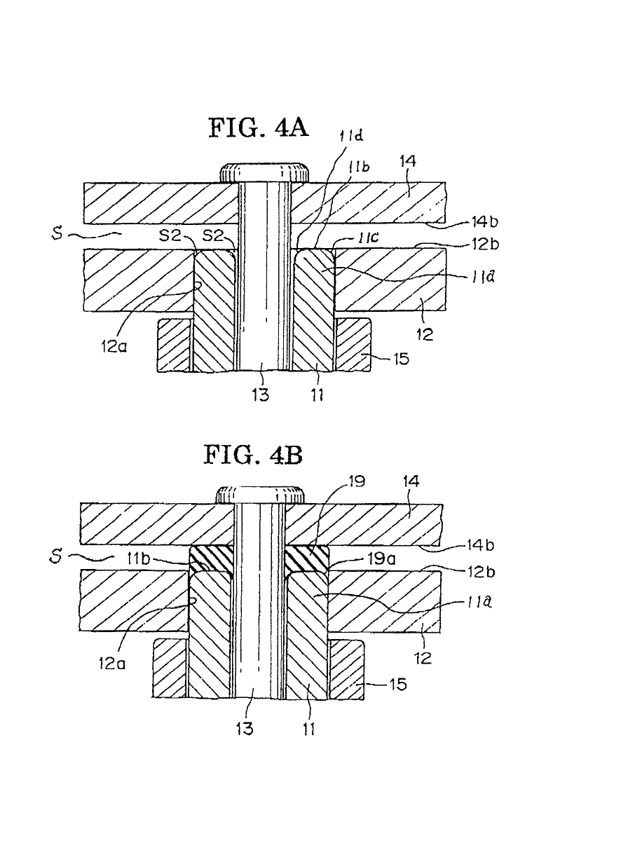

FIGS. 4A and 4B show a main portion of a sealed chain according to a forth embodiment of the present invention. The sealed chain differs from those of the preceding embodiments shown in FIGS. 1A, 1B, 2 and 3 in that an end face 11b of the bushing 11 lies flush with an outer side surface 12b of the inner link plate 12; an annular space S2 is defined between a rounded outer edge 11c of the end face 11b of the bushing 11 and the peripheral wall 12a of a gushing hole 12c of the inner link plate 12 and also between a rounded inner edge 11d of the end face 11b of the bushing 11 and the outer circumferential surface of the pin 13; and a circular seal ring 19 (FIG. 4B) of an elastic material is disposed between the inner side surface 14b of the outer link plate 14 and the end face 11b of the bushing 11, the seal ring 19 having inner and outer seal lips 19a projecting from inner and outer peripheral edges of one end face of the seal ring 19 in the axial direction and being elastically engaged in the annular spaces S2.

In the illustrated embodiment, the radius of curvature (R) of the rounded edges 11c, 11d is ¼ of the thickness (t) of the bushing 11. The radius of curvature (R) of the rounded edges 11c, 11d and the thickness (t) of the bushing 11 preferably have a relationship represented by the expression t/10 R.

By virtue of the annular spaces S2 formed between the end portion 11a of the bushing 11, the peripheral wall 12a of the bushing hole 11c of the inner link plate 12 and the circumferential surface of the pin 13 and receiving therein the seal lips 19a of the seal ring 19, it is possible to provide a necessary space for installation of the seal ring 19 without displacing the outer link plate 14 in an axial outward direction of the pin 13. Accordingly, the width of the sealed chain is prevented from becoming larger than that of the standard chain.

The sealed chain of the construction shown in FIGS. 4A and 4B is able to achieve substantially the same effects as the sealed chain shown in FIGS. 1A and 1B.

Despite the rounded edges 11c, 11d formed at both inner and outer peripheral edges of the end face 11b, the bushing 11 may have only one rounded edge formed at either the inner edge or the outer edge of the end face 11b, in which instance the seal ring 19 has a single seal lip corresponding in position to the rounded edge.

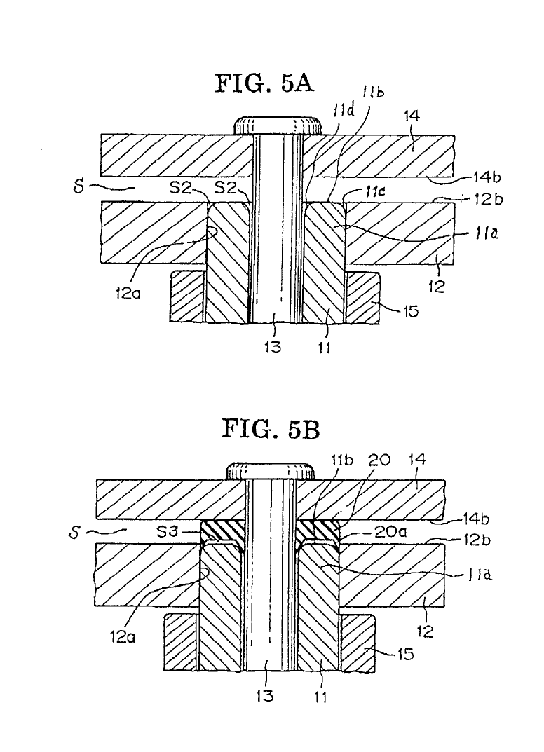

FIGS. 5A and 5B show a main portion of a sealed chain according to a fifth embodiment of the present invention. The sealed chain is structurally the same as the sealed chain of the fourth embodiment shown in FIGS. 4A and 4B with the exception that,a circular seal ring 20 and an end face 11b of the bushing 11 define therebetween a closed annular space S3 and retain a lubricating agent (not shown) such as a lubricating oil within the annular space S3. The lubricating agent held inside the space S improves the wear resistance of the seal ring 20. The sealed chain shown in FIGS. 5A and 5B can achieve the same effects as the sealed chain shown in FIGS. 4A and 4B.

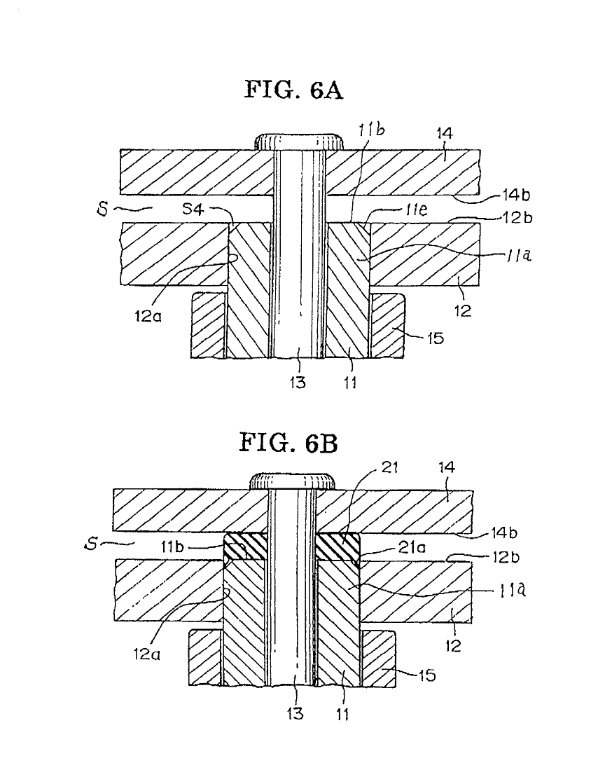

FIGS. 6A and 6B illustrate a main portion of a sealed chain according to a sixth embodiment of the present invention. The sealed chain of this embodiment is structurally the same as the sealed chain of the fourth embodiment shown in FIGS. 4A and 4B with the exception that the outer edge of the end face 11b of the bushing 11 is beveled as at lie rather than rounded. The beveled outer edge 11e of the end face 11b of the bushing 11 and the peripheral wall 12a of the bushing hole 12c of the inner link plate 12 define therebetween an annular space S4 (FIG. 6A) in which an annular seal lip 21a of a circular seal ring 21 (FIG. 6B) is elastically engaged.

In the illustrated embodiment, the width (C) of the beveled edge 11e is ¼ of the thickness (t) of the bushing 11. It is preferable that the width (C) of the beveled edge lie and the thickness (t) of the bushing 11 have a relationship represented by the expression C≦t/2.

In the sealed chain shown in FIGS. 6A and 6B, the beveled outer edge 11e of the end face 11b of the bushing 11 and the peripheral wall 12a of the bushing hole 12c of the inner link plate 12 define therebetween an annular space S4 connected to a space S formed between the inner side surface 14b of the outer link plate 14 and the inner side surface 12b of the inner link plate 12 (and also between the inside surface 14b of the outer link plate 14 and the end face 11b of the bushing 11). By thus forming the annular space S4, it is possible to accommodate a part (seal lip) 21a of the seal ring 21 within the space S4. Thus, the seal ring 21 can be installed in the space S between the inner side surface 14b of the outer link plate 14 and the end face 11b of the bushing 11 without displacing the outer link plate 14 in an axial outward direction of the pin 13. This ensures that the sealed chain has the same width as the standard chain.

The sealed chain shown in FIGS. 6A and 6B is able to achieve substantially the same effects as the sealed chain shown in FIGS. 1A and 1B.

The beveled edge 11e may be formed either one or both of the outer and inner peripheral edges of the end face 11b of the bushing 11. It is apparent that the number and position of the seal lip 21a used in combination with the beveled edge 11e correspond to the number and position of the beveled edge.

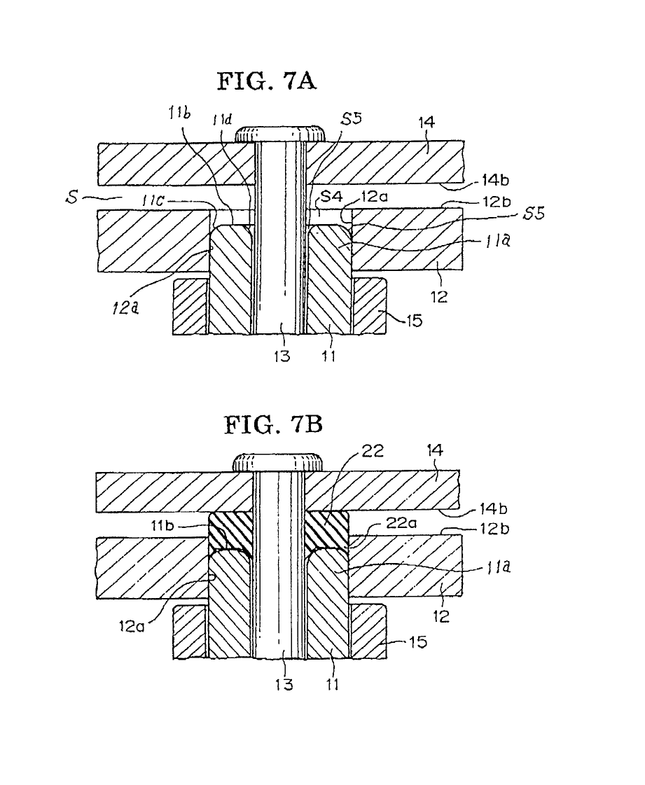

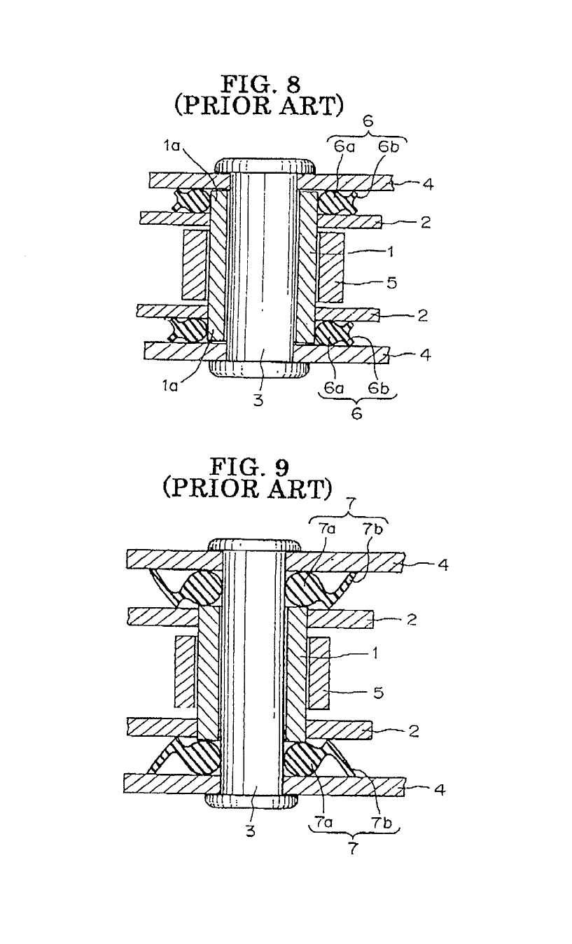

FIGS. 7A and 7B show a main portion of a sealed chain according to a seventh embodiment of the present invention. The sealed chain of this embodiment is a modification of the sealed chain of the first embodiment shown in FIGS. 1A and 1B. A main difference from the first embodiment is that the end face 11b of the bushing 11, retracted from an outer side surface 12b of the inner link plate 12, is rounded at both outer and inner edges as at 11c and 11d (FIG. 7A). By thus rounding the inner and outer edges of the end face 11b, the annular space S1 defined jointly between the end face 11b of the bushing 11, the peripheral wall 12a of the bushing hole 12c of the inner link plate 12 and the outer circumferential surface of the pin 13 has an axial end extension S5 formed between the rounded outer edge 11c of the end face 11b and the peripheral wall 12a of the bushing hole 12c and also between the rounded inner edge 11d of the end face 11b and the circumferential surface of the pin 13.

A seal member comprising of a circular seal ring 22 is fitted around the outer circumferential surface of the pin 13 and disposed between the inner surface 14b of the outer link plate 14 and the end face 11b of the bushing 11 with a lower portion received in the space S1. Annular seal lips 22a projecting from inner and outer peripheral edges of a lower end face of the seal ring 22 are elastically engaged in the axial end extensions S5 of the space S1.

In the sealed chain shown in FIGS. 7A and 7B, partly because the end face 11b of the bushing 11 retracted from the inner side surface 12b of the inner link plate 12 forms, jointly with the peripheral wall 12a of the bushing hole 12c and the outer circumferential surface of the pin 13, an annular space S1 for receiving therein a part of the seal ring 22, and partly because the rounded edges 11c, 11d of the end face 11b of the bushing 11 further provide axial end extensions S5 of the annular space S1, even a relatively thick seal member such as the seal ring shown in FIG. 7B can be installed without displacing the outer link plate 14 in an axial outward direction of the pin 13. With this arrangement, the sealed chain is prevented from becoming larger in width than the standard chain.

The sealed chain shown in FIGS. 7A and 7B achieves substantially the same effects as the sealed chain shown in FIGS. 1A and 1B.

In the illustrated embodiments, the present invention is applied to a roller chain. The invention can be also applied to bush chains or silent chains. The sealed chains in the illustrated embodiments are of the simplex type composed of a single strand of chain. The present invention may be applied to a duplex chain or a multiplex chain composed of more than two strands of chains disposed in side by side.

The number of the seal member used in one sealed chain as well as the shape and configuration, color and performance characteristics of the seal member can be changed depending on conditions of use of-the sealed chain. This means that a single sealed chain may have plural seal members of different types.

The present invention can be applied to all of the sealed chains used for power transmission as in motorcycles or for conveyance as in general industrial machines.

Obviously, various minor changes and modifications of the present invention are possible in the light of the above teaching. It is therefore to be understood that within the scope of the appended claims, the present invention may be practiced otherwise than as specifically described.

What is claimed is:

1. A sealed chain comprising:
two opposed inner link plates each having a bushing hole formed therein;
a bushing having opposite end portions press-fit in the bushing holes of the inner link plates;
two opposed outer link plates disposed exteriorly of the inner link plates in the widthwise direction of the chain;
a pin loosely fitted in the bushing and having opposite end portions firmly connected to the outer link plates, there being a first space defined between an inner side surface of each of the outer link plates and an outer side surface of one inner link plate opposite to the outer link plate; and
a seal member of an elastic material fitted around an outer circumferential surface of the pin and disposed at least between the inner side surface of the outer link plate and an end face of the bushing,
wherein each of the opposite end portions of the bushing and at least one of the outer circumferential surface of the pin and a peripheral wall of the bushing hole together define therebetween a second space connected to a first space, and the seal member is partly received in the second space.

2. The sealed chain according to claim 1, wherein the end face of the bushing is retracted from the outer side surface of the inner link plate, and the second space is defined between the end face of the bushing, the outer circumferential surface of the pin, and the peripheral wall of the bushing hole of the inner link plate.

3. The sealed chain according to claim 2, wherein the seal member comprises an O-ring.

4. The sealed chain according to claim 2, wherein the seal member comprises a flanged O-ring having a body of a circular cross section and an annular flange extending from the circular body in a radial outward direction, the circular body being disposed between the inner side surface of the outer link plate and the end face of the bushing, and the annular flange being disposed between the inner side surface of the outer link plate and the outer side surface of the inner link plate.

5. The sealed chain according to claim 4, wherein the circular body of the flanged O-ring has an amount of elastic deformation smaller than that of the annular flange of the flanged O-ring.

6. The sealed chain according to claim 3, further including an X-ring of an elastic material disposed between the inner side surface of the outer link plate and the outer side surface of the inner link plate.

7. The sealed chain according to claim 6, wherein the O-ring has an amount of elastic deformation smaller than that of the X-ring.

8. The sealed chain according to claim 2, wherein at least one of inner and outer peripheral edges of the end face is rounded, the rounded peripheral edge of the end face and one of the peripheral wall of the bushing hole of the inner link plate and the outer circumferential surface of the pin jointly form an axial end extension of the second space, and the seal member has an annular seal lip elastically engaged in the axial end extension of the second space.

9. The sealed chain according to claim 1, wherein the end face of the bushing lies flush with the outer side surface of the inner link plate, at least one of inner and outer peripheral edges of the end face is rounded, the second space is defined between the rounded peripheral edge of the end face and one of the peripheral wall of the bushing hole of the inner link plate and the outer circumferential surface of the pin, and the seal member has an annular seal lip elastically engaged in the second space.

10. The sealed chain according to claim 9, wherein the radius of curvature of the rounded peripheral edge is greater than or equal to 1/10 of the thickness of the bushing.

11. The sealed chain according to claim 10, wherein the radius of curvature of the rounded peripheral edge is 1/4 of the thickness of the bushing.

12. The sealed chain according to claim 9, wherein the end face of the bushing and the seal member define therebetween a closed annular space and retain a lubricating agent within the closed annular space.

13. The sealed chain according to claim 1, wherein the end face of the bushing lies flush with the outer side surface of the inner link plate, at least one of inner and outer peripheral edges of the end face is beveled, the second space is defined between the beveled peripheral edge of the end face of the bushing and one of the peripheral wall of the bushing hole of the inner link plate and the outer circumferential surface of the pin, and the seal member has an annular seal lip elastically engaged in the second space.

14. The sealed chain according to claim 13, wherein the width of the beveled peripheral edge is smaller than or equal to ½ of the thickness of the bushing.

15. The sealed chain according to claim 14, wherein the width of the beveled peripheral edge is ¼ of the thickness of the bushing.
